(19) United States
(12) Patent Application Publication
(10) Pub. No.: US 2024/0149264 A1
(43) Pub. Date: May 9, 2024

(54) METHODS AND APPARATUS FOR EVAPORATION BASED LIQUID TRANSPORT

(71) Applicant: VIRGINIA TECH INTELLECTUAL PROPERTIES, INC., Blacksburg, VA (US)

(72) Inventors: Jiangtao CHENG, Blacksburg, VA (US); Xukun HE, Blacksburg, VA (US)

(21) Appl. No.: 18/281,503

(22) PCT Filed: Mar. 11, 2022
(86) PCT No.: PCT/US2022/019971

§ 371 Date: Sep. 11, 2023

Related U.S. Application Data
(60) Provisional application No. 63/159,782, filed on Mar. 11, 2021.

(51) Int. Cl. B01L 3/00

(52) U.S. Cl. CPC B01L 3/502; B01L 2200/0673; B01L 2300/161; B01L 2400/0466

(57) ABSTRACT

This disclosure provides an apparatus, including a first plate having a first transport surface and a second plate having a second transport surface. The second plate is positioned at an acute angle with respect to the first plate such that a first transport surface of the first plate faces the second transport surface of the second plate. The first transport surface and the second transport surface are hydrophobic. The apparatus also includes one or more liquid droplets positioned between and in contact with the first transport surface and the second transport surface. During evaporation, the liquid droplet will automatically move towards the cusp of the first plate and the second plate.

### CROSS-REFERENCE TO RELATED APPLICATIONS

This application claims priority to U.S. Provisional Patent Application No. 63/159,782, entitled “Topography-guided Colloidal Transport and Assembly in An Evaporating Liquid Droplet,” filed Mar. 11, 2021, the entirety of which is incorporated by reference herein.

### TECHNICAL FIELD

This disclosure relates to liquid transport between non-parallel surfaces based on evaporation.

### DESCRIPTION OF THE RELATED TECHNOLOGY

Evaporation of a sessile liquid droplet can lead to the enrichment and settlement of the contained analytes or colloidal particles after its complete evaporation, which can be used in various applications including biosensing [1], bio/chemical analyses in droplet-based microfluidic systems [2, 3] and nanomaterial syntheses [4, 5]. As such, evaporation can be utilized to extract solutes or to achieve the self-assembly of colloidal particles for the syntheses of nanodevices [6, 7]. When combined with sensing techniques such as surface-enhanced Raman spectroscopy (SERS) [8, 9] and matrix-assisted laser desorption/ionization mass spectrometry (MALDI-MS) [10], the well-controlled droplet evaporation could be applied to concentrate the analytes on the sensing spot for the detection and identification of the targeted analytes/molecules with ultralow concentrations [8].

### SUMMARY

In some aspects, the techniques described herein relate to an apparatus, including: a first plate having a first transport surface; a second plate having a second transport surface, the second plate positioned at an acute angle with respect to the first plate such that a first transport surface of the first plate faces the second transport surface of the second plate, where the first transport surface and the second transport surface are hydrophobic; and one or more liquid droplets positioned between and in contact with the first transport surface and the second transport surface.

In some aspects, the one or more liquid droplets include suspended colloidal particles or components. In some aspects, the acute angle has a value less than 90°. In some aspects, the apparatus has a narrow end and a broad end, and wherein the first plate and the second plate make contact near the narrow end. In some aspects, the apparatus has a narrow end and a broad end, and wherein the first plate and the second plate define a gap near the narrow end. In some aspects, the first transport surface and the second transport surface have a coating including at least one of thiol, fluoropolymer or a hydrophobic agent.

In some aspects, the first plate and the second plate each have a length between tens of nanometers to several centimeters. In some aspects, the apparatus has narrow end and a broad end, and wherein the one or more liquid droplets, while in the process of evaporation, moves from the broad end to the narrow end without external driving force or momentum. In some aspects, the one or more liquid droplets have a volume between tens of nanoliters to several microliters or even large volume reaching tens of milliliters. In some aspects, at least one of the first transport surface and the second transport surface has a curved surface.

In some aspects, the techniques described herein relate to a method for evaporation-based transport of fluid, including: positioning a liquid droplet at a first end of a transport apparatus, the apparatus including: a first plate extending between the first end and a second end of the transport apparatus, and a second plate positioned at an angle with the first plate, the second plate extending between the first end and the second end of the transport apparatus, the liquid droplet positioned between the first plate and the second plate nearer to the first end of the transport apparatus, providing conditions for inducing evaporation in the liquid droplet, causing the liquid droplet to move from the first end towards the second end of the transport apparatus.

In some aspects, the liquid droplet is positioned between a first transport surface on the first plate and a second transport surface on the second plate, and wherein the first transport surface and the second transport surface are hydrophobic surfaces. In some aspects, the hydrophobic surfaces include at least one of thiol, fluoropolymer or a hydrophobic agent. In some aspects, the at least one of the first transport surface and the second transport surface has a curved surface.

In some aspects, the techniques described herein relate to a method, further including: suspending colloidal particles or components in the liquid droplet. In some aspects, the angle has a value that is less than 90°. In some aspects, the first plate and the second plate make contact at the second end. In some aspects, the first plate and the second plate define a gap near the second end. In some aspects, the first plate and the second plate each have a length between tens of nanometers to several centimeters. In some aspects, the liquid droplet moves from the first end to the second end without external driving force or momentum.

### BRIEF DESCRIPTION OF THE DRAWINGS

FIG. 1 shows a side view of a first example droplet transport apparatus.

FIG. 2 shows a top view of the first example droplet transport apparatus.

FIG. 3 shows a second example droplet transport apparatus where a first plate and a second plate do not make contact.

FIG. 4 shows a third example droplet transport apparatus having a non-planar transport surface.

FIG. 5A shows a schematic illustration of a droplet confined between two non-parallel hydrophobic surfaces,

FIG. 5B illustrates forces exerted on a confined droplet.

FIG. 5C shows a top view of the droplet contact base and contact line on the plate surface.

FIGS. 6A-6C sho snapshots of the lateral transport of evaporating droplets from different locations.

FIG. 6D shows the corresponding evolution of the contact angles during the evaporation and transport process.

FIG. 7A shows the displacement of a left rim and a right rim of a contact line of the confined droplets with different initial positions.

FIG. 7B shows the evolution of the lateral locomotion of the confined droplets during evaporation,

FIG. 7C shows the instantaneous velocity of the confined droplets during evaporation.

FIG. 7D shows the evolution of the confinement factor of the evaporating droplets with different initial positions.

FIG. 8A shows simulated equilibrium shapes of a water droplet confined at different locations.

FIG. 8B shows the contact angle distribution along the contact zone based on simulations.

FIG. 8C shows the corresponding frictional force distribution along the contact zone based on simulations.

FIG. 9A shows the evolution of the free energy G of the confined droplet with varying lateral locations.

FIG. 9B shows the evolution of the force components on a confined droplet at different lateral positions.

FIG. 10A shows the lateral displacement of an evaporating water droplet with shrinking volume and the relaxation map of the confined droplets at different locations with varying volume.

FIG. 10B shows the evolution of dimensionless deviation of the evaporating droplets from the instantaneous equilibrium location during the transport.

FIGS. 11A-11C show snapshots of the lateral transport of evaporating droplets confined between two non-parallel hydrophobic surfaces with various dihedral angles.

FIG. 11D shows the corresponding lateral transport of the evaporating droplets.

FIG. 11E shows the evolution of the velocity of the transporting droplets between two non-parallel hydrophobic surfaces with various dihedral angles.

FIG. 12A shows that simulated equilibrium position of the confined droplet follows a linear relationship during evaporation.

FIG. 12B shows a phase map of the relaxation states of the confined droplets with different droplet locations and volumes in the non-parallel hydrophobic surfaces with varying dihedral angle.

Like reference numbers and designations in the various drawings indicate like elements.

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used in the specification and the appended claims, the singular forms “a,” “an” and “the” include plural referents unless the context clearly dictates otherwise. Thus, for example, reference to “a proton beam degrader,” “a degrader foil,” or “a conduit,” includes, but is not limited to, two or more such proton beam degraders, degrader foils, or conduits, and the like.

The various concepts introduced above and discussed in greater detail below may be implemented in any of numerous ways, as the described concepts are not limited to any particular manner of implementation. Examples of specific implementations and applications are provided primarily for illustrative purposes.

As used herein, the terms “optional” or “optionally” means that the subsequently described event or circumstance can or cannot occur, and that the description includes instances where said event or circumstance occurs and instances where it does not. Unless otherwise specified, temperatures referred to herein are based on atmospheric pressure (i.e., one atmosphere).

Evaporation of sessile droplets can be used for various applications, such as biosensing, bio/chemical analysis in droplet based microfluidic systems, and nanomaterial synthesis. The prescribed transport of the sample droplet towards the specific sensing spot before its complete evaporation can aid in accurate screening of targeted analytes. Traditionally, especially inspired by droplet motion on spider silk [11], cactus spines [12], and Cotula fallax plant [13], the directional transport of droplet has been realized through various strategies: (1) wettability gradient induced by surface textures [14], chemical functionalizations [15], thermal gradient or electrowetting effect [17, 18]; (2) external body forces including gravity [19], magnetic force and electric force [21]; and (3) Laplace pressure difference due to the confinement in asymmetric geometries [11, 22-28]. However, the complex geometric structures, extra force/temperature/concentration fields, and functionalized surfaces with fragile micro/nanostructures involved in these technologies still restrict their practical applications. Therefore, a passive method for the prescribed droplet transport on a simple platform or apparatus is still highly desired.

In some instances, a capillary ratchet mimicking the shorebird beak with two non-parallel hydrophilic surfaces, i.e., wedge-shaped or V-shaped structure, has been applied to directionally transport the liquid bridge by periodically open-close the beak-like structure [26]. This solution, however, involves complex mechanical operations. The evaporation of colloidal liquid bridges formed between two non-parallel hydrophilic surfaces and their special drying patterns have been reported [29, 30]. However, in these studies, it was hard for the liquid bridges to get stabilized at a specific location because of the dominant effect of Laplace pressure [25, 31]. As a result, the liquid bridge quickly moved towards and filled the corner of the V-shaped groove and the deposition pattern of solute/colloidal particles was not concentrated within a relatively small footprint due to the coffee-ring effect [29, 32, 33]. This drawback is addressed in the apparatus discussed herein, where lower-energy surfaces, i.e., hydrophobic surfaces can be utilized, to achieve the controllable transport of droplets in a passive manner while suppressing the coffee-ring effect. While some previous studies simply ascribe the asymmetric evaporation to the capillary force [27, 34] the embodiments discussion herein employ the effects of V-shaped geometry on both the evaporation and transport of a liquid droplet confined therein.

Through a series of experimental measurements, numerical simulation, and theoretical analysis, the description herein focuses on dynamic motion of an evaporating droplet confined between two non-parallel hydrophobic surfaces with dihedral angle a by addressing the following questions. In particular, the discussion addresses issues such as (1) behavior of asymmetrically confined droplet between two non-parallel hydrophobic surfaces during evaporation (2) Effect of droplet volume, droplet location and dihedral angle on the confined droplet motion, and (3) underlying mechanisms of this evaporation-triggered directional transport of the confined droplet. The description herein provides a comprehensive force and energy analysis on the confined droplet. In addition, the Surface Evolver simulation results of the three-dimensional (3D) morphology of the asymmetrically confined droplet are included to validate the theoretical analyses in the context of the experimental observations. The discussion herein presents a new approach to developing droplet-based microfluidic cargo system by taking advantage of asymmetric structures, in which the evaporation-triggered actuation of the confined droplet could be employed to achieve the simultaneous droplet directional transport and solute enrichment in otherwise inaccessible and extremely constrained regions.

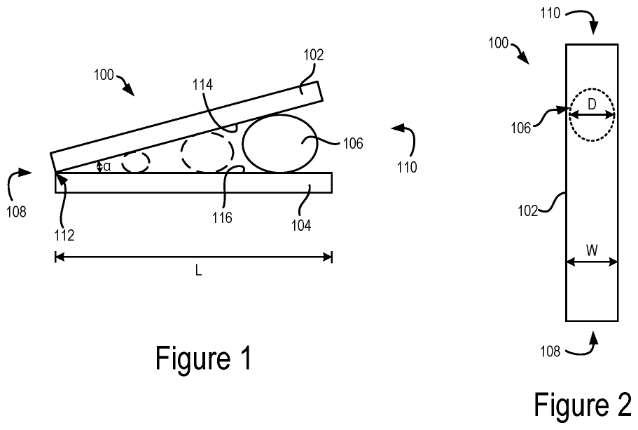

FIG. 1 shows a side view of a first example droplet transport apparatus 100. In particular, FIG. 1 shows the first example droplet transport apparatus 100 including a first plate 102 and a second plate 104. The first plate 102 and the second plate 104 are positioned at an angle α in relation to each other. The first example droplet transport apparatus 100 further includes one or more liquid droplets 106 positioned between the first plate 102 and the second plate 104. The first example droplet transport apparatus 100 can include a narrow end 108 (also referred to as “a second end”) and a broad end 110 (also referred to as “a first end”). Both the first plate 102 and the second plate 104 extend between the narrow end 108 and the broad end 110. The perimeters of the first plate 102 and the second plate 104 are closer to each other near the narrow end 108 than near the broad end 110. In the example shown in FIG. 1, the first plate 102 and the second plate 104 make contact near the narrow end 108 to form a cusp 112. The angle a can be an acute angle with a value that is less than 90 degrees. Under evaporating conditions, the one or more liquid droplets 106 will move from the broad end 110 to the narrow end 108. This movement of the one or more liquid droplets 106 occurs without application of any additional external forces, including gravity.

The first plate 102 and the second plate 104 can be formed of a solid material. Any material can be used, such as metals, plastics, glass, wood, semiconductor, ceramics, metamaterials, etc., and the choice of material may depend upon the application in which the first example droplet transport apparatus 100 is used. The first plate 102 has a first transport surface 114 and the second plate 104 has a second transport surface 116. The first transport surface 114 faces the second transport surface 116. The one or more liquid droplets 106 is positioned between, and in contact with, the first transport surface 114 and the second transport surface 116. The first transport surface 114 and the second transport surface 116 can be hydrophobic surfaces. In some instances, the first transport surface 114 and the second transport surface 116 can be treated to behave as hydrophobic surfaces. For example, the first transport surface 114 and the second transport surface 116 can have a coating comprising at least one of thiol, fluoropolymer, or any other hydrophobic agent. In some instances, the first transport surface 114 and second transport surface 116 can have micro-structures that impart hydrophobicity. Hydrophobicity implies that a contact angle of a liquid droplet on the first transport surface 114 or the second transport surface 116 can be in the range of 90 degrees to 125 degrees. In some instances, the first transport surface 114 and the second transport surface 116 could be superhydrophobic, in which case the contact angle can be greater than 125 degrees.

The first plate 102 and the second plate 104 can have a length L that can range from a few nanometers to a lOs of centimeters. The actual length L can depend upon the type of application the first example droplet transport apparatus 100 is employed in. for example, in colloidal particle assembly applications, where the first example droplet transport apparatus 100 is used to assemble colloidal particles such as, for example, nanoparticles, suspended in the one or more liquid droplets 106, the length L can be in the order of nanometers. In another example, in cooling applications, where the first example droplet transport apparatus 100 is used as a heat pipe, the length L can be a few to 10s of centimeters. In some instances, the length L can be a function of the size of the one or more liquid droplets 106. For example, the length L can be at least a few times to more than ten times greater than the diameter of the one or more liquid droplets 106 at the broad end 110. In some examples, the length of the second plate 104 and the one or more liquid droplets 106 can be generally unequal, and can be again a function of the application in which the first example droplet transport apparatus 100 is employed. In some examples, the one or more liquid droplets 106 can have a volume between tens of nanoliters to several microliters or even large volume reaching tens of milliliters.

FIG. 2 shows a top view of the first example droplet transport apparatus 100. The top view shows the first plate 102 and an outline of the one or more liquid droplets 106 positioned under the first plate 102. The first plate 102 can have a width W, which can be equal to or greater than a diameter D of the one or more liquid droplets 106. In particular, the width W of the first plate 102 can be wide enough to ensure that the one or more liquid droplets 106 is stable between the first plate 102 and second plate 104. The width of the second plate 104 can be equal to the width of the first plate 102, however, the relative widths of the first plate 102 and second plate 104 can be different, while their minimum widths can be dictated by the diameter D of the one or more liquid droplets 106.

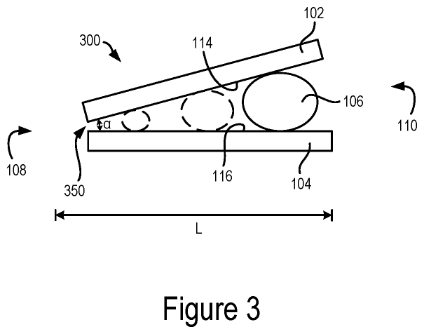

Referring back to FIG. 1, the first plate 102 and the second plate 104 make contact at the cusp 112 near the narrow end 108. In some instances, the first plate 102 and the second plate 104 may not make contact at the cusp 112, and instead have a gap therebetween near the 108. For example, FIG. 3 shows a second example droplet transport apparatus 300 where the first plate 102 and the second plate 104 do not make contact. In particular, the perimeter of the first plate 102 and the perimeter of the second plate 104 define a gap 350 at the narrow end 108. It should be noted that the presence of the gap 350 may not affect the angle a between the first plate 102 and the second plate 104. In some applications, the presence of the gap 350 can aid in allowing access to the droplet. For example, the gap 350 can be used to access or probe assembled colloidal particles after the one or more liquid droplets 106 has evaporated. A frame structure (not shown) can be provided to support the first plate 102 and the second plate 104 in positions that result in defining the gap 250.

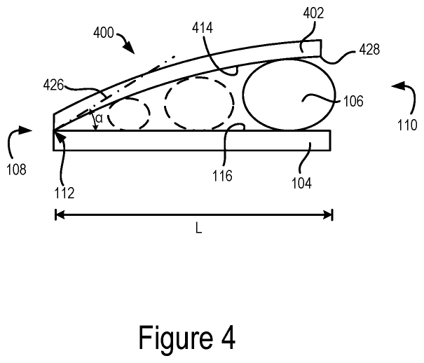

While FIG. 1 shows the first transport surface 114 and the second transport surface 116 as planar, these surfaces can be non-planar or have a non-linear cross-section. For example, FIG. 4 shows a third example droplet transport apparatus 400 having a non-planar transport surface. In particular, the third example droplet transport apparatus 400 includes a curved first plate 402 which has a curved shape. More specifically, the curved first plate 402 includes a curved first transport surface 414, unlike the planar first transport surface 114 shown in FIG. 1. In some instances, the second transport surface 116 may also be curved or non-planar. In some examples, the curvature of the curved first transport surface 414 can be selected to alter the rate of movement of the one or more liquid droplets 106 from the broad end 110 to the narrow end 108. In some instances, the angle α can be measured between the planar second transport surface 116 and a tangent 426 to the curved first transport surface 414 at the cusp 112. In some examples, the angle α can be measured between the planar second transport surface 116 and a line segment extending between the cusp 112 and the extremity of the curved first plate 402, such as the corner 428. In some examples, the third example droplet transport apparatus 400 can be modified in a manner similar to the second example droplet transport apparatus 300, shown in FIG. 3, to include a gap 250 instead of the cusp 112.

In some instances, the direction of curvature of the curved first plate 402 can be opposite of what is shown in FIG. 4. That is, while FIG. 4 shows the curved first plate 402 having a convex portion facing the second transport surface 116, in some instances, the convex portion could face away from the second transport surface 116. In some instances, where the second plate 104 is also curved, the direction of the curvatures of the two plates can be selected as desired. In some instances, the degree of curvature of the two plates can be the same. In some other instances, the degree of curvature of the first plate can be different from the degree of curvature of the second plate. The configuration of the first plate and the second plate with regards to the curvature and orientation can be selected based on the application in which the apparatus is used and can, in part, be based on the desired rate of movement of the one or more liquid droplets 106 and the stability of the one or more liquid droplets 106.

The one or more liquid droplets 106 can have a volume that is between tens of nanoliters and several microliters or even larger volumes reaching tens of milliliters. In some applications, the one or more liquid droplets 106 can include water or other liquids such as, for example, alcohol, biofluids, organic liquids, etc. In some instances, the liquid can be selected based on the rate of evaporation of the liquid under given conditions, where the rate of evaporation of the droplet can affect the rate of transport of the droplet from the broad end 110 to the narrow end 108.

During operation, the one or more liquid droplets 106 can be positioned between the first transport surface 114 (or the curved first transport surface 414) and the second transport surface 116. The manner in which the one or more liquid droplets 106 is positioned between the first transport surface 114 and the second transport surface 116 can depend upon the application and the size of the droplets. In some instances, where the apparatus is used for cooling, the one or more liquid droplets 106 may be deposited by way of condensation of the vapor state of the liquid. In some instances, the one or more liquid droplets 106 could be positioned via a syringe containing the liquid. In other instances, pipettes or micropumps could also be used.

The apparatus can be exposed to conditions that allow for the evaporation of the one or more liquid droplets 106. Again, this can be application driven, and can include controlling of parameters such as temperature, humidity, exposure to photons, etc. The values of these parameters can also depend, in part, on the properties of the liquid used. Nevertheless, as long as the one or more liquid droplets 106 can undergo evaporation, the one or more liquid droplets 106 is capable of movement between the two plates. It should be noted that to induce movement, no external forces are needed. For example, the movement of the liquid can be independent of the gravitational force acting on the apparatus, as the capillary action forces dominate the movement dynamics of the one or more liquid microdroplets 106. As a result, the apparatus can operate regardless of the spatial orientation in which it is placed. Further, unlike traditional applications, which utilized mechanical, magnetic, gravitational, etc., forces to induce the movement in the droplet, the apparatus discussed herein passively induces the movement of the one or more liquid droplets 106 independent of such external forces.

1. Experimental and Simulation Setup: The following section provides details of example experimental and simulation setup for analyzing the properties and functioning of the apparatus discussed above. The values of various experimental and simulation parameters are only examples and are not limiting.

### 1.1 Hydrophobic Surfaces Preparation and Experimental Setup

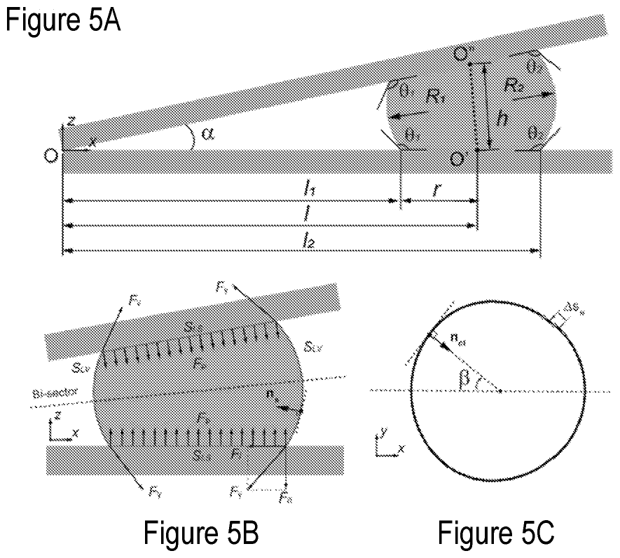

The hydrophobic plate surfaces can be prepared by firstly cutting a silicon wafer into pieces with the dimension of 2 cm×1 cm. It should be noted that while in the experimental setup, the plates were made of silicon, the plates could potentially made of other materials as discussed above. The pieces of silicon wafer were primed by spin-coating with fluoropolymer (PFC 1601V, Cytonix Corporation) at 3000 rpm for 30 s. While fluoropolymer can be used as one example material to impart hydrophobicity, other hydrophobic coatings such as, for example, thiol coating, and Teflon® can also be utilized. After the samples being baked at 160° C. for 1 hour, the static contact angle θ of water microdroplet on the samples could reach 118°±1°, while its advancing contact angle θₐ and receding contact angle θᵣ were measured as 123° and 107°, respectively. To study the transport of evaporating droplets confined between two non-parallel surfaces, one of the two prepared samples was first mounted onto a vertically adjustable linear-stage. And the other sample was attached on the edge of a tiltable platform with a tilt-range of —25°˜25°. Then a deionized (DI) water droplet of 4±0.1 μL was deposited on the lower sample surface on stage #1, which was incrementally moved upwards till touching the upper sample surface on the stage #2. In this way, an initially stable droplet was confined between the two non-parallel surfaces. The configuration of the experimental setup is illustrated in FIG. 5A, in which the dihedral angle α and the initial position l₀ of the confined droplet can be controlled by tilting the inclination of the upper platform and by adjusting the horizontal distance between the upper and lower surfaces. It has been demonstrated that an unstable liquid bridge would be automatically propelled towards the apex of two non-parallel hydrophilic surfaces within only a few seconds[24, 25]. Therefore, after the droplet being sandwiched between the two non-parallel hydrophobic surfaces in FIG. 5A, a wait time of at least 30 s was included to ensure that the confined droplet dwelling at a distance l₀ from the cusp was initially in a stable or quasi-stable state.

The evaporation experiment setup includes a custom-designed transparent chamber with the dimension of 20 cm×20 cm×20 cm, in which the relative humidity (RH) was controlled at 35-40% and the ambient temperature was maintained at 21±1° C. An integrated camera on the contact angle measurement system (Theta Lite, OneAttension Corporation) can be used to capture the transient images of the evaporating droplet at a rate of 1.14 frames per second. The reproducibility of the experiments was verified by repeating each case at least three times.

### 1.2 Simulation Setup

In a previous study [35], the evaporation of squeezed droplets between two parallel hydrophobic/superhydrophobic surfaces was found to be significantly suppressed due to the vapor enrichment inside the confined space. Thus, in the apparatus discussed herein, it is assumed that the evaporation of confined droplets between two non-parallel surfaces is a quasi-steady process, which means the transient shape of an evaporating droplet could be approximated by its profile at the equilibrium

state. Using an open-accessed software such as, for example, Surface Evolver [36], the profile of an evaporating droplet can be obtained by minimizing its surface energy under a set of constraints. In addition to the constraints of constant volume and static contact angle, the algorithm developed by J. A. White[37, 38] was implemented to account for the potential effect of contact angle hysteresis (CAH) on the contact line motion as following: (1) The dimensionless force fᵢ=Fᵢ/γ_{LV}Δl on certain vertex i along the solid-liquid-vapor triple-phase contact line is obtained from Surface Evolver by resorting a virtual displacement of the confined droplet, where Fᵢ (as shown in FIG. 5B) is the force on the vertex, γ_{LV} is the interfacial tension of liquid-vapor interface and Δl is the length of the two edges connected with the vertex; (2) The modulus of the dimensionless force fᵢ is compared with the maximum friction force fₘₐₓ. If fᵢ>fₘₐₓ, the vertex is allowed to move, otherwise the vertex is kept fixed. Here, the modulus of fₘₐₓ is dependent on whether the vertex is advancing or receding:

f_{a_max}=cos θ−cos θₐ (1)

f_{r_max}=cos θᵣ−cos θ (2)

where the advancing contact angle θₐ and the receding contact angle θᵣ are chosen based on the experimental measurements during evaporation. The static contact angle θ is the averaged value of θₐ and θᵣ. The detailed algorithm of this computational process is shown in the flowchart of FIG. S1 in the Supplementary Materials of [55].

Besides, droplet volume V, dihedral angle α and distance l are three adjustable parameters in the Surface Evolver simulation that determine the equilibrium shape and position of the droplet. To eliminate the mesh-size effect, the number of the mesh grids Nₘₑₛₕ was initially set as 8200 to model the liquid-vapor interface of the droplet. During the simulation, the mesh was further optimized by implementing two internal functions, i.e., “Equiangulation (u)” and “Vertex Averaging (V)”, and a user-defined function that can refine or delete the excessively long or short edges. The predicted values of the contact radii of the confined droplet with varying α and l were found to be consistent with experimental values as shown in FIG. S2 in the Supplementary Materials of [55], which can validate the methodology of the Surface Evolver simulation.

2. Theoretical Analysis

### 2.1 The Stability of Confined Droplet Between Two Non-Parallel Surfaces

In general, the stability of a liquid bridge sandwiched between two non-parallel surfaces is determined by two necessary conditions [31, 39]. First, the pressure inside the liquid droplet should be uniform so that the droplet can stay in equilibrium, thus the following geometrical relationship should be satisfied [23, 31]:

$$\frac{cos ( {θ}_{2} + \frac{α}{2} )}{cos ( {θ}_{1} - \frac{α}{2} )} > 1 \qquad ( 3 )$$

If the two surfaces are hydrophilic, θ₁ should be larger than θ₂+α, otherwise the instability induced by Laplace pressure difference inside the droplet could drive the droplet to move to the cusp. If the surfaces are hydrophobic, θ₁<θ₂+α is required to reach droplet stability, which could be satisfied in all the three potential conditions of θ₁<θ₂, θ₁=θ₂, and θ₁>θ₂, indicating that the dynamics, especially the moving direction, of the droplet confined between two non-parallel hydrophobic surfaces is indecisive. Even though this indecisive manner had been observed in previous work, no

insightful explanation has been given [23]. Second, all the forces acting on the mass center of the droplet need to be balanced, entailing a comprehensive force analysis on the droplet between two non-parallel hydrophobic surfaces.

### 2.2 Force Analysis of the Confined Droplet

The gravity effect on the dynamics of the evaporating microdroplet is neglected due to the small Bond number (Bo=ρgh²/γ_{LV}˜0.1, where ρ is water density and g is the gravity constant), which is evidenced by the almost identical contact radii of the confined droplet on both the upper and lower surfaces (FIG. S3 in the Supplemental Materials of [55]). Thus, besides the surface tension force along the solid-liquid-vapor triple-phase contact line (cl), only the pressure-induced forces on the liquid-vapor interface S_{LV} and on the top and bottom liquid-solid interfaces 2S_{LS} are considered in the force analysis as shown in FIG. 5B.

The Laplace pressure-induced force Fₚ on the confined droplet can be calculated by integrating the pressure over the liquid-solid surface area 2S_{LS} and the liquid-vapor surface area S_{LV}:

Fₚ=∫_{S}_{_{LV}}pₐnₛdS+∫_{2S}_{_{LS}}(pₐ+p_{γ})nₛdS=∫_{S}_{_{LV}}_{+2S}_{_{LS}}pₐnₛdS+∫_{2S}_{_{LS}}p_{γ}nₛdS (4)

where pₐ is the atmospheric pressure, which could be regarded as a constant, and nₛ is the unit inward normal vector of the droplet surface. Based on the Young-Laplace equation, the Laplace pressure p_{γ} inside the droplet could be estimated as p_{γ}≈2 γ_{LV}H, where the liquid-vapor interface tension γ_{LV}=0.072 N/m for water and H is the mean curvature of the liquid-vapor interface.

Based on Gauss's theorem, the first term on the right-hand side of Eq. 4 is zero as a result of the integration of a constant over an enclosure, thus the magnitude of Fₚ on one liquid-solid interface S_{LS} can be estimated as the pressure-induced force:

Fₚ=∫_{S}_{_{LS}}2γ_{LV}H dS≈2 πr^{2γ}_{LV}H (5)

where r is the contact radius on the plate surface. Note that the mean curvature H could be directly calculated by averaging the curvatures of the 3D equilibrium morphology of the droplet based on the Surface Evolver simulation. Besides, if only the 2D shapes of the confined droplet were collected from experiments, based on some approximations shown in Section S3, H could also be estimated as:

$$H \approx \frac{1}{2} ( \frac{2 cos θ}{h} + \frac{1}{r} ) \qquad ( 6 )$$

where h is the height of the droplet as depicted in FIG. 5A. The surface tension force along the contact line F_{γ} could be decomposed into two components, i.e., the lateral (in-plane) adhesion force Fₗ and the normal adhesion force Fₙ. Here, the lateral adhesion force Fₗ on the contact line can be regarded as the friction force F_{f}, and the magnitude of friction force F_{f} could be obtained as:

$${F}_{f} = {\int }_{cl} {γ}_{LV} cos θcosβ dl \approx {\sum }_{N = 1}^{{N}_{max} = {N}_{cl}} {γ}_{LV} cos {θ}_{N} cos {β}_{N} Δ {s}_{N} \qquad ( 7 )$$

where β is the azimuthal angle along the contact line as shown in FIG. 5C. In the Surface Evolver simulation, F_{f} could be estimated in the discrete form, in which N_{cl} is the number of vertices on the contact line and Δs_{N} is the length of contact line element connected to the Nth vertex. θ_{N} and β_{N} are the local contact angle and the azimuthal angle of the Nth vertex, respectively. Here, the droplet contact area on the plate surfaces is approximated by a circular shape, which will be verified in Section 3.2. According to Eq. 7, they component of γ_{LV} cos θ of the friction force F_{f} on the top or bottom plate surface is cancelled. In 2D form, Eq. 7 could be approximated as F_{f}≈πγ_{LV}r(cos θₐ−cos θᵣ), indicating that the asymmetric contact angle difference due to contact angle hysteresis (θₐ−θᵣ) is the origin of the lateral adhesion force.

In the context of Surface Evolver, the magnitude of normal adhesion force Fₙ on the contact line can be obtained as:

$${F}_{n} = {\int }_{cl} {γ}_{LV} sin θ dl \approx {\sum }_{N = 1}^{{N}_{max} = {N}_{cl}} {γ}_{LV} sin {θ}_{N} Δ {s}_{N} \qquad ( 8 )$$

To apply the global force balance, all the abovementioned three forces on the top and bottom solid-liquid interfaces and on the triple-phase contact lines need to be projected onto the bisector (FIG. 5B) as:

$${\underbrace{2 {\int }_{{S}_{LS}} 2 {γ}_{LV} H sin \frac{α}{2} {n}_{s} dS}}_{{F}_{p}^{′}} + {\underbrace{2 {\int }_{cl} {γ}_{LV} cos θcos \frac{α}{2} {n}_{cl} dl}}_{{F}_{f}^{′}} {\underbrace{- 2 {\int }_{cl} {γ}_{LV} sin θsin \frac{α}{2} {n}_{s} dl}}_{{F}_{n}^{′}} = ρ Va \qquad ( 9 )$$

where F′ₚ, F′_{f} and F′ₙ are the projections of all the pressure-induced force Fₚ, lateral adhesion force F_{f} and normal adhesion force Fₙ on the bisector, respectively. And the acceleration of the droplet a=0 if all the forces are balanced.

Here, the direction of F′ₙ is dependent on the wettability of the surfaces, which always points to the cusp O between hydrophobic surfaces; the direction of F′ₚ is dependent on the mean curvature H, which always points away from the cusp O if the surfaces are hydrophobic; the direction of F′_{f} depends on the contact angle distribution along the contact line (cos θ₁−cos θ₂ in 2D), which was found to be determined by the resultant force of F′ₚ and F′ₙ based on experimental and simulation results, which will be discussed in detail in Section 3.2.

### 2.3 Energy Analysis of Droplet Behaviors n Confined Space

To further elucidate droplet behaviors between two non-parallel surfaces, surface energy analysis on the confined droplet can be conducted. The Gibbs free energy G for the confined droplet can be approximated as [40, 41]:

G=γ_{LV}S_{LV}+(γ_{LS}−γ_{SV})S_{LS} (10)

where γ_{LS} and γ_{SV} are the liquid-solid interfacial tension and the solid-vapor interfacial tension, respectively. Eq. 10 could be simplified by Young's equation γ_{LS}−γ_{SV}=−γ_{LV}cos θ as:

G=γ_{LV}(S_{LV}−S_{LS} cos θ) (11)

Based on the Surface Evolver simulation, the free energy G of the confined droplet with different volumes between the two non-parallel surfaces with varying dihedral angle α could be obtained. To incorporate the free energy evolution with the mass reduction during evaporation, the surface energy could be estimated in terms of droplet volume V, droplet location l, and dihedral angle α:

$$G = 2 {γ}_{LV} \sqrt{πα lV} ( 1 - \sqrt{\frac{V}{{π}^{3} {α}^{3} {l}^{3}}} cos θ ) \qquad ( 12 )$$

where two approximations, i.e., the droplet height could be approximated as h=αl and the droplet body could be approximated by the cylindrical shape, were taken in the derivation of Eq. 12, since the droplet contact angle θ˜110° is not remarkably deviated from 90° and the dihedral angle is significantly smaller than the contact angle (α«θ). According to Eq. 12, the free energy G would decrease with decreasing droplet volume V during evaporation. Moreover, as the confined droplet moves towards the cusp with decreasing l, the trends of the two components

$${l}^{\frac{1}{2}} and {l}^{- \frac{3}{2}}$$

in Eq. 12 are contrary, which might lead to an equilibrium location lₑ with the lowest surface energy

For a droplet with a certain volume V confined between two non-parallel surfaces with fixed dihedral angle α, this equilibrium location l e could be obtained by assuming the derivative of the free energy with respect to lateral displacement dG/dl=0. That is:

$${l}_{e} = \frac{- 2 {k}_{e} cos θ}{α} {( \frac{V}{π} )}^{\frac{1}{3}} ∼ {α}^{- 1} {V}^{\frac{1}{3}} \qquad ( 13 )$$

where kₑ is the correction factor of the two approximations above. According to Eq. 13, this equilibrium location would continuously shift towards the cusp, i.e., lₑ→0 as V→0, during the evaporation, manifesting the evaporation-triggered directional transport of an evaporating droplet.

### 3. Results and Discussion

### 3.1 Evaporation-Triggered Lateral Transport of Droplets Confined Between Two Non-Parallel Hydrophobic Surfaces

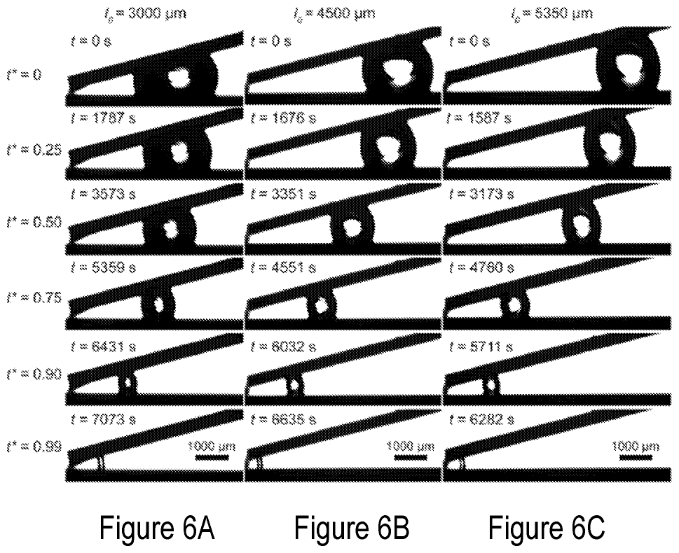

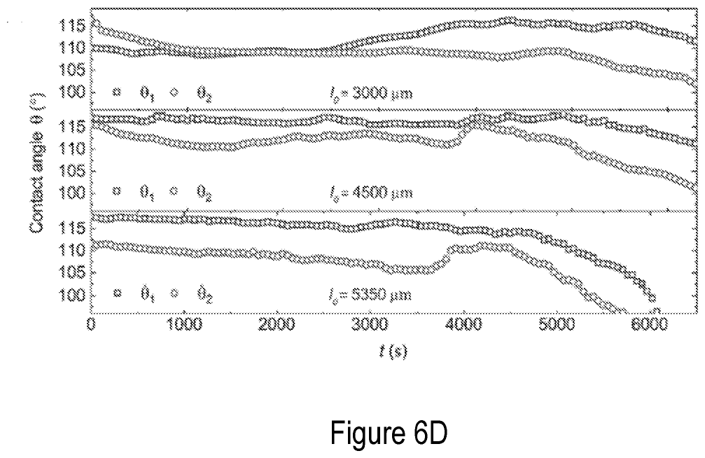

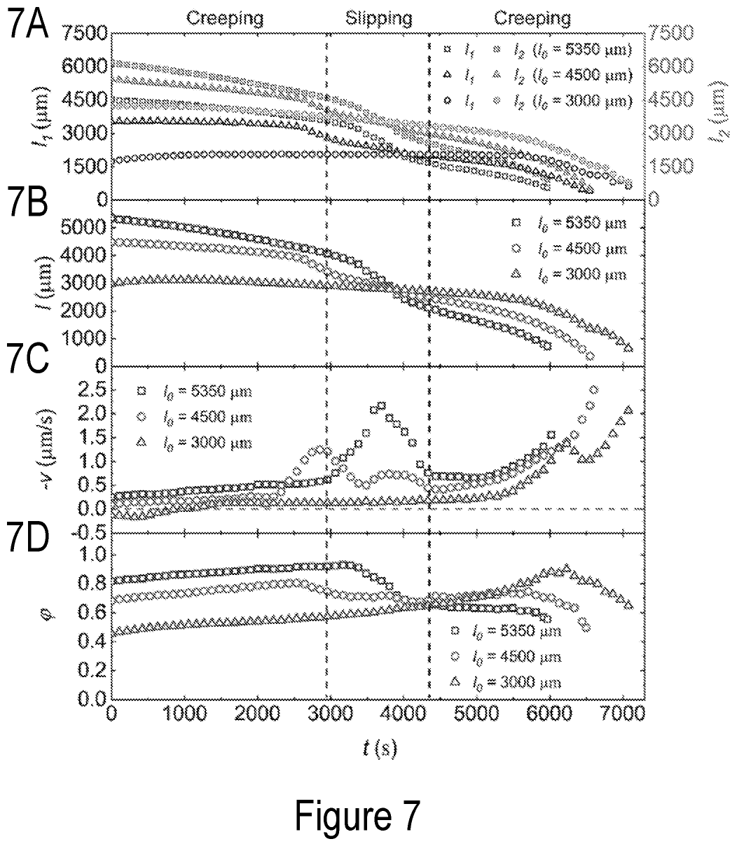

The behaviors of evaporating water droplets with an initial volume of 4 μL, which were confined between two non-parallel hydrophobic surfaces with a fixed dihedral angle α=14° but at different initial locations l₀=3000μm , 4500 μm and 5350 μm, are shown in FIGS. 6A, 6B, and 6C, respectively. For each case with the different initial position l₀, the snapshots were displayed at different dimensionless time t*=t/tₜ, where tₜ is the total evaporation lifetime of each case. The corresponding evolutions of contact angles of the droplets during evaporation are presented in FIG. 6D. Similar to findings of droplet evaporation between two parallel hydrophobic surfaces in [35], the apparently prolonged evaporation time (˜2 hours) of the droplets dwelling between non-parallel surfaces indicates that evaporation was also greatly suppressed therein due to the substantial vapor enrichment within the confined space. However, the continuously shrinking contact line and the contact angle distribution of the evaporating droplet in the configuration of non-parallel surfaces are not symmetric anymore. And all the three confined droplets were observed to spontaneously transport towards the cusp O during evaporation. To quantitatively study the transport process, the corresponding contact line motions, lateral displacements and velocities of the evaporating droplets are illustrated in FIGS. 7A-7C, respectively.

As shown in FIG. 7A, even at the early stage of droplet evaporation (t≤1500 s), the receding motions of the contact line are distinctly asymmetric: (a) For the case with l₀=5350 μm, both the left and right sides of the contact line moved towards the cusp; (b) For the case with l₀=4500 μm, only the right side contact line moved towards the cusp while the left side contact line got pinned; (c) For the case of l₀=3000 μm, the right side contact line got pinned while the left side contact line receded away from the cusp. Correspondingly, during this early stage, the initial moving directions of the droplets were totally different for these three cases with different initial states, i.e., the confined droplet with the farthest initial location from the cusp O (l₀=5350 μm) would move towards the cusp while the droplet with the nearest initial location from the cusp O (l₀=3000 μm) would move away from the cusp, which are manifested by the increasing or decreasing l shown in FIG. 7B and the different signs of velocity shown in FIG. 7C. Moreover, the opposite directions of droplet movement in this stage are consistent with the distinct contact angle distributions (θ₁<θ₂ with l₀=3000 μm; θ₁≈θ₂ with l₀=4500 μm; and θ₁>θ₂ with l₀=5350 μm as shown in FIG. 6D) due to the asymmetric confinement and the existence of CAH. And if the advancing and receding contact lines are identified based on these contact angle distributions, the receding contact line is found to be always actuated earlier (l₀=3000 μm, 4500 μm) or faster (l₀=5350 μm) than the advancing contact line, which can be explained by the fact that the droplet's initial contact angle at the to-be-receded side is much closer to the receding contact angle (θᵣ≈θ₁<θ₂<θₐ for l₀=3000 μm and θᵣ≈θ₂<θ₁<θₐ for l₀=5350 μm). In essence, the evaporation-triggered lateral motion of droplets during this early stage is mainly induced by the asymmetric motion of contact lines.

After the droplets evaporated to a certain volume, all the three confined droplets began moving towards the cusp. Especially in the case of l₀=3000 μm, the direction of droplet motion was reversed at t=1500 s, which is in agreement with the advancing-receding transition of the contact line shown in FIG. 6D (the crossover of the θ₁ and θ₂ curves). And the directional transport of droplets towards the cusp was sustained during the majority period of their evaporation. Generally, there are two modes of locomotion during this directional transport of One is the creeping mode, during which the evaporating droplet moves towards the cusp with a relatively small velocity (˜0.3 μm/s) and could be regarded as a quasi-steady motion. The other is the slipping mode, during which the evaporating droplet slips a relatively long distance in a short period, i.e., with a relatively faster speed. For instance, the evaporating droplet in the case of l₀=5350 μm experienced a relatively large displacement during the short period of 3173 s˜4760 s, which is confirmed by the significantly reduced l (Δl=1940 μm) as shown in FIG. 7B and the acceleration-deceleration pulse (|vₘₐₓ|=2.1 μm/s) as shown in FIG. 7C. And this relatively rapid slipping motion was also observed in the cases of l₀=3000 μm and l₀=4500 μm. Nevertheless, their displacement Δl in this slipping mode and the magnitude of the maximum velocity |vₘₐₓ| also decrease with decreasing l₀.

Before its complete evaporation (t*≥0.99), the remaining droplet bridge usually got stuck near the cusp with the continuously decreasing contact angle and shrinking contact radii. Finally, upon the rupture of the evaporating liquid bridge, two sessile daughter droplets with almost identical volumes formed on the upper and lower surfaces, respectively, till their complete evaporation thereon. During the whole process, the evaporation rate of the directionally transported droplet would be significantly suppressed by the decreasing droplet height h, leading to enhanced vapor concentration in the narrower space (cusp). Besides, the contact angle evolution during evaporation and transport is mainly determined by three factors, i.e., static contact angle hysteresis [42], dynamic contact angle hysteresis [42, 43] and evaporation-induced contact angle reduction. As such, the static contact angle hysteresis and evaporation-induced contact angle reduction are dominant in the creeping mode whereas the dynamic contact angle hysteresis is more influential in the slipping mode. Detailed discussion about droplet evaporation dynamics can be found in Section S2 and Section S4 of Supplementary Materials of [55].

For each case with l₀ ranging from 3000 μm to 5350 μm, the droplet initially experiences stronger confinement as evidenced by their correspondingly larger deformation. Here, a dimensionless factor φ=h/V^{1/3} can be defined, where h is the distance between the centroids of droplet contact areas on the top and bottom plates, to quantify the magnitude of confinement on the droplet. Accordingly, the confined droplet during evaporation might be under three stress states, i.e., the squeezed state (smaller φ), the stretched state (larger φ) and the moderately stressed state between those two states. The real-time variations of the confinement factor cp during droplet evaporation is plotted in FIG. 7D. The continuously increasing cp in the creeping mode indicates that the stress state of the confined droplet is gradually transferred to the stretched state. Subsequently, the occurrence of slipping motion after the apex of these φ−t curves and the stepwise reduction of cp during the slipping mode suggest that the slipping motion might result from the stretch-induced instability with apparent deviation from the equilibrium state, which is discussed in detail in the following section.

### 3.2 Energy Analysis and Global Force Analysis on the Evaporating Droplet

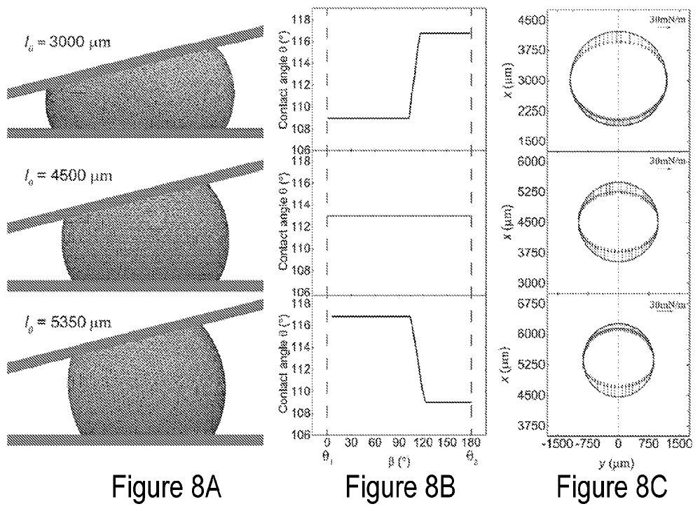

The morphologies of a 4 μL water droplet confined between two non-parallel hydrophobic surfaces with α=14° and at positions l₀=3000 μm, 4500 μm, and 5350 μm, respectively, were simulated by Surface Evolver. As plotted in FIG. 8A, the simulated morphologies of the confined droplets for these cases are consistent with the experimental snapshots at t=0 s as shown in FIGS. 6A-6C. According to the simulation, different geometric confinements and constraints on the droplet at different locations do result in different contact angle distributions as shown in FIG. 8B, indicating that the contact angle θ would evolve from θ₁ at the leftmost rim to θ₂ at the rightmost rim along the periphery of the contact area. As droplet location changes from l₀=5350μm to l₀=3000μm, the evolution of contact angle distribution in the x-y plane (FIG. 5C) is consistent with the experimentally measured initial contact angle θ₁ and θ₂ as shown in FIG. 6D, which validates the simulation results. Moreover, the distributions of the friction force F′_{f} along the contact line are distinct as displayed in

FIG. 8C, which are in excellent agreement with the different directions of droplet actuation at the onset of evaporation as discussed in the previous section.

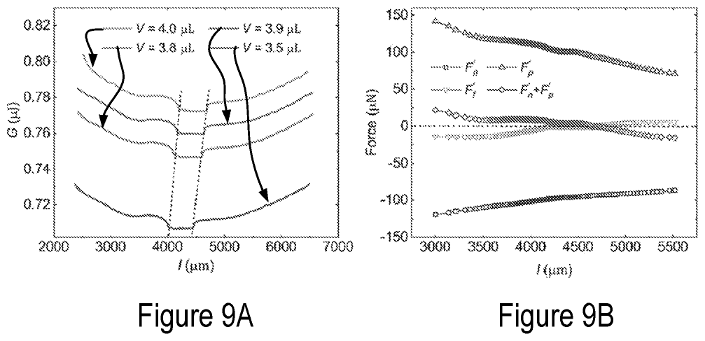

To investigate the effects of the lateral position and hence the local asymmetric constraint on droplet dynamics, the dihedral angle α=14° was fixed and the morphology evolution of a confined droplet was simulated with its volume V in the range of 0-4 μL at different locations of ˜2300 μm-6500 μm. Based on Eq. 13, an equilibrium position lₑ with the minimum free energy G could be located for a droplet with a certain volume, which is manifested by the valley of each G−l curve in FIG. 9A. Being that the contact angle hysteresis was taken in to account in the simulation, the equilibrium position is actually located within a zone, which is demarcated by the minimum boundary lₑₘᵢₙ and the maximum boundary lₑₘₐₓ, rather than a specific location. Essentially, the droplet is self-propelled towards this equilibrium zone to minimize its free energy G. Therefore, the observed opposite directions of droplet actuations in the cases of l₀=3000 μm and 5350 μm at the beginning of evaporation could be elucidated as the relocation process of the confined droplet towards its instantaneous equilibrium zone. For a droplet with a certain volume, the relocation of the droplet would eventually end with its settlement in the equilibrium zone (lₑₘᵢₙ≤lₑ≤lₑₘₐₓ). However, in the case of an evaporating droplet with decreasing volume V, the equilibrium location lₑ˜α⁻¹V^{1/3} of the droplet is found to shift towards the cusp O with the continuously shrinking volume (FIG. 9A), finally reaching the cusp with its complete evaporation, i.e., lₑ=0with V=0. The evaporation-induced decreasing lₑ should be the origin of the directional transport of an evaporating droplet towards the cusp of the non-parallel surfaces.

Based on Eqs. 5-9, the Laplace-pressure-induced force F′ₚ, the friction force F′_{f} and the normal adhesion force F′ₙ exerted on a 4 μL confined droplet can be calculated and plotted versus the corresponding droplet position l in FIG. 9B. The equilibrium zone (4250 μm≤lₑ≤4670 μm) based on the energy analysis is consistent with the mechanical equilibrium location where the normal adhesion force F′ₙ is balanced with the Laplace-pressure-induced force F′ₚ (the friction force F′_{f} would become negligible in this force-balanced zone due to the small contact angle difference |θ₁−θ₂|). This consistency could be validated by the re-derivation of the scaling law of equilibrium position lₑ˜α⁻¹V^{1/3} in Eq. 13 by assuming |F′ₙ|=|F′ₚ| based on Eqs. 5-9:

$$\frac{2 sin θ - 1}{cos θ} = \frac{2 r}{h} \qquad ( 14 )$$

Also based on the two approximations that the droplet volume could be estimated as V≈πr²h and the droplet height could be approximated as h−αl, then the equilibrium position lₑ could be derived as:

$${l}_{e} = {{k}_{f} ( \frac{16 V}{{πα}^{3}} {( \frac{cos θ}{2 sin θ - 1} )}^{2} )}^{\frac{1}{3}} ∼ {α}^{- 1} {V}^{\frac{1}{3}} \qquad ( 15 )$$

where k_{f} is a correcting factor to the assumptions made. Based on the simulation results of Surface Evolver, Eq. 15 could successfully predict lₑ if the correction factor kₑ in Eq. 13 and k_{f} in Eq. 15 are taken as 1.19 and 0.66, respectively.

Therefore, from the perspective of force balance, the relocation of an evaporating droplet towards a position with the minimum free energy G could also be interpreted as the competing result between F′ₙ and F′ₚ. As such, if l≤lₑₘᵢₙ, F′ₚ is the force driving the droplet away from the cusp; if l>lₑₘₐₓ, F′ₙ is the force propelling the droplet towards the cusp; and if lₑₘᵢₙ≤l≤lₑₘₐₓ, the droplet remains static due to the force balance.

The effects of surface wettability on the directional transport of evaporating droplets could also be predicted based on force analysis. For a droplet confined between two hydrophobic surfaces, as the contact angle θ decreases during evaporation, the normal adhesion force F′ₙ would gradually increase and approach the maximum value at θ=90° whereas the Laplace pressure-induced force F′ₚ would decrease towards the minimum value due to the decreasing surface curvature H. Therefore, the smaller F′ₚ and the larger F′ₙ should be two of the main sources of the acceleration near the end of evaporation as shown in FIG. 7C. In particular, the smaller resultant force of F′ₙ+F′ₚ on the stronger hydrophobic surfaces or the superhydrophobic surfaces (with θ>150°) could explain the failure of directional transport of evaporating droplets confined between two micro-structured superhydrophobic surfaces as shown in Section S5 of Supplementary Materials of [55].

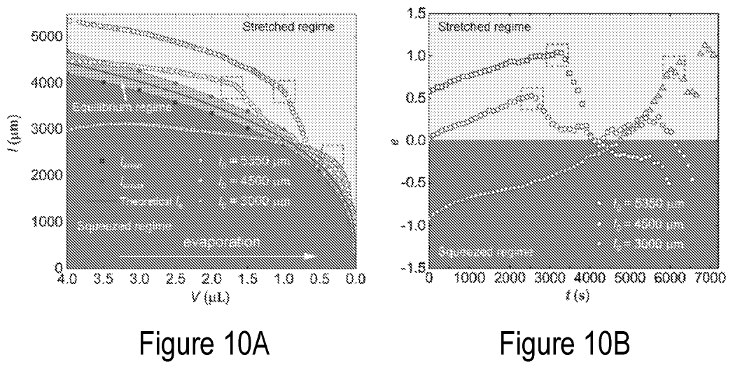

The simulated equilibrium zone of an evaporating droplet with the diminishing volume V from 4 μL to 0 μL were fitted and plotted in FIG. 10A, in which the whole map is divided by the curves of lₑₘₐₓ and lₑₘᵢₙ into three regimes for the confined droplet, i.e., the squeezed (SQ) regime (F′ₙ>F′ₚ while l<lₑₘᵢₙ), the equilibrium (EQ) regime (F′ₙ≈F′ₚ while lₑₘᵢₙ≤l≤lₑₘₐₓ), and the stretched (ST) regime (F′ₙ<F′ₚ while l>lₑₘₐₓ) This phase map also shows the experimentally measured displacements of three evaporating droplets confined between two non-parallel hydrophobic plates from different initial position l₀=3000 μm, 4500 μm, and 5350 μm, respectively. It can be seen that the three droplets were initially located in three different regimes at the onset of their evaporation. And the characteristics of this evaporation-triggered transport could be summarized from the map. Despite its initial state, the evaporating droplet would follow the complete or partial sequence of SQ→EQ→ST→EQ in a successive fashion. For example, the droplet at the initially squeezed regime (l₀=3000 μm) followed the complete sequence of SQ→EQ→ST→EQ. Whereas the droplet initially at the stretched regime (l₀=5350 μm) only experienced the last step of the transition, i.e., from the stretched regime to the equilibrium regime (ST→EQ).

To further clarify the origin of this evaporation-triggered motion and the two distinct modes during the transport, the dimensionless deviation factor e=(l−lₑ)/V^{1/3} where lₑ=(lₑₘₐₓ+lₑₘᵢₙ)/2 can be defined. And the instantaneous evolutions of deviation factor e for the three cases are depicted in FIG. 10B. Indeed, the value and the sign of the deviation factor e could be used to quantify the direction and the relative magnitude of the acceleration of the evaporating droplet, respectively, i.e., the droplet at the location with a larger deviation always owns the stronger acceleration pointing towards the equilibrium zone (e˜0). As shown in FIG. 10B, the deviation factor e started increasing from the beginning of evaporation, indicative of the procrastinated droplet motion in the creeping mode while accumulating deviation. Once the droplet reached a certain location with the largest deviation, the stimulated instability finally drives the droplet to slip towards the equilibrium state in a very short period (slipping mode). The similar spontaneous motion of a liquid bridge between two non-parallel hydrophilic surfaces due to the instability had been reported in several previous studies [25, 31, 44]. During the whole transport process, each evaporating droplet oscillates around its instantaneous equilibrium location (e=0), indicating that the dynamics of an evaporating droplet could be regarded as a self-relaxation process from the squeezed state or the stretched state to the equilibrium state. Therefore, it is reasonable to arrange the droplet initially at the stretched state with a larger e to take advantage of this unstable slipping motion for quicker transport of the evaporating droplet.

### 3.3 The Effects of Dihedral Angle on the Lateral Transport of Evaporating Droplets

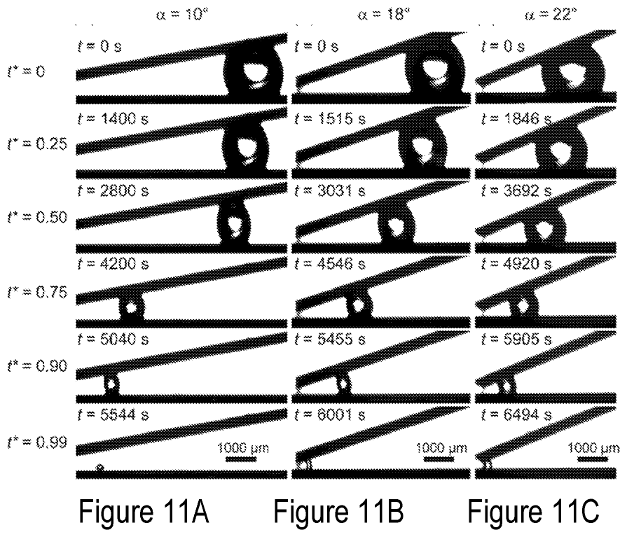

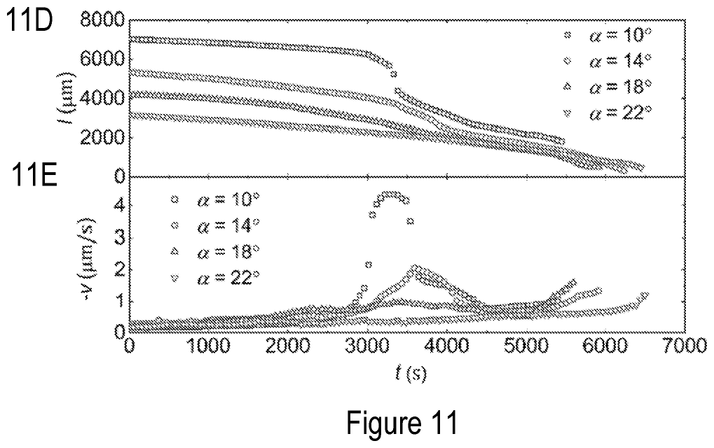

To investigate the effects of geometric confinement on droplet evaporation and transport dynamics between two non-parallel hydrophobic surfaces, the dihedral angles a of the two surfaces was varied from 10° to 22° while the initial location l₀ of droplets were tuned to ensure the droplets in the similar stretched regime, i.e., setting the initial height of each confined droplet h₀≈hₛ, where hₛ is the initial height of the sessile droplet deposited on the bottom surface. FIGS. 11A-11C are the representative snapshots of the directional transport of evaporating droplets confined between two non-parallel hydrophobic surfaces with a =10°, 18°, and 22°, respectively. As expected, all the confined droplets were eventually transported towards the cusp of the two non-parallel surfaces. With the increasing dihedral angle α, the droplet would reach closer to the cusp at the end of its complete evaporation, which is evidenced by the fact that the droplet in the configuration of dihedral angle α=10° finally detached from the upper surface at l₌₁₇₀₀ μm whereas the droplet finally reached the cusp O in the case of α=22°.

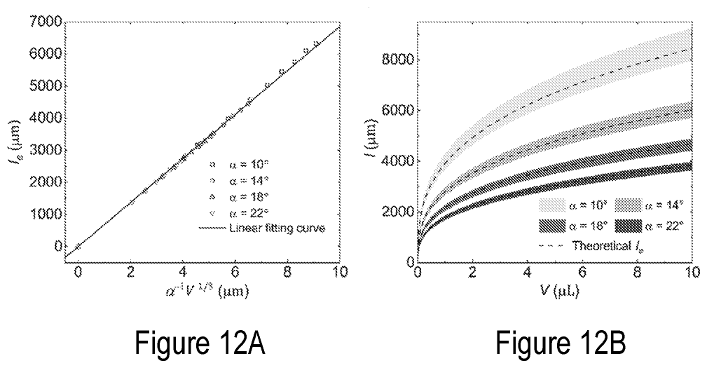

The displacements and instantaneous velocities of the evaporating droplets for cases of α=10°, 14°, 18°, and 22° are illustrated in FIGS. 11D and 11E, respectively. Both the creeping mode and the slipping mode of droplet motion were observed in the cases of α=10°, 14°, and 18°, whereas the droplet was observed to move only in the creeping mode between surfaces with α=22°. Moreover, the crest of droplet velocity in the acceleration-deceleration process of the slipping mode decreases as a increases. To elucidate the depressed slipping mode with increasing dihedral angle a, the equilibrium locations lₑₘₐₓ, lₑₘᵢₙ and lₑ of the confined droplets were numerically obtained with volume V in the range of 0 to 10 μL between two non-parallel hydrophobic surfaces with dihedral angle α in the range of 10°˜22°. The linear relationship between lₑ and α⁻¹V^{1/3} as shown in FIG. 12A validates the scaling law of lₑ˜α⁻¹V^{1/3} (Eq. 13 and Eq. 15). Besides, the values of lₑₘᵢₙ and lₑₘₐₓ can be regressed in the form of lₑ =CV 113 (C is a constant coefficient varying for lₑₘᵢₙ and lₑₘₐₓ), demarcating the bandwidth of each equilibrium zone as plotted in FIG. 12B.

As shown in FIG. 12B, for an evaporating droplet confined between two non-parallel hydrophobic surfaces with dihedral angle a, the overall trend of the lₑ−V evolution becomes more flattened with increasing a, indicating that the equilibrium location lₑ would laterally shift a shorter distance for the same volume reduction in the configuration with a larger α. For instance, if droplet volume is reduced from 10 μL to 6 μL, the corresponding equilibrium position shifts Δlₑ≈1500μm for the case of α=10° whereas Δlₑ≈600 μm for the case of α=22°. Nonetheless, regarding the four cases with varying a in the range of 10°˜22°, the displacements of droplets in the creeping mode before the slipping motion are very small and almost identical. Therefore, for the case with the smallest dihedral angle α=10°, the deviation e from the droplet real-time location l to the equilibrium location lₑ became so large (eₘₐₓ˜2.45) that the instability could trigger the droplet to slip over a relatively longer distance to the equilibrium location lₑ. For the case with the largest dihedral angle α=22°, the deviation e is relatively small (eₘₐₓ˜0.39) during the whole process so that no apparent slipping motion could be observed in this case. Furthermore, as the dihedral angle α increases, the bandwidth of the equilibrium zone gradually decreases, indicating that the influence of CAH on droplet motion becomes weaker due to the stronger component of the driving force associated with a larger dihedral angle α (Eq. 9).

Note that the phase map of FIG. 12B can be used to not only elucidate the transport mechanism of an evaporating droplet but also to predict the dynamics of a droplet confined between two non-parallel surfaces under the open/close or squeezed/stretched cycles. Moreover, this map could be applied to explain the suspension of growing embryos inside the V-shaped cavity in the micro-structured surface during dropwise condensation [34, 45, 46]. If the condensate embryo is initially formed at the bottom of the surface cavity, the growing embryo/droplet will continuously move upward since the instantaneous equilibrium position lₑ keeps moving away from the cavity base in the order of α⁻¹V^{1/3} (Eq. 13 and Eq. 15).

The directional transport of an evaporating droplet confined between two non-parallel hydrophobic surfaces is theoretically, experimentally, and numerically presented above in relation to the embodiments discussed. Even though the asymmetric contact line motions of either shrinking or growing droplets inside V-shaped grooves have been reported in only few previous studies [27, 34], however, in their analyses, the

asymmetric motions were simply attributed to capillary forces and the driving effect of gravity on droplets could not be excluded in their vertical configurations [27, 34]. In contrast, the evaporation-triggered droplet transport discussed herein is indicative of an actuation mechanism, which is generally ignored in state-of-the-art modeling of droplets in complex structures [23, 27, 34, 39, 47, 48] or microfluidics in a porous medium [49, 50].

According to the Surface Evolver simulation and theoretical analysis, an equilibrium location lₑ of a confined droplet owning the lowest surface energy G and force balance is recognized. Along with the evaporation-induced volume reduction, evaporating droplet would chase this instantaneous equilibrium location lₑ, which consecutively shifts towards the cusp of the two non-parallel surfaces. Here, the scaling law of the morphology/volume-dependent equilibrium location is theoretically unveiled, which could not only elucidate the directional transport of the shrinking droplet during evaporation [27, 34] or the growing embryo during condensation[34, 45, 46] inside the asymmetric geometric structures, but also explain the motion dynamics of droplets being asymmetrically squeezed or stretched as reported in several prior studies [22, 23, 34]. Moreover, two kinds of droplet motion modes, i.e., the creeping mode and the slipping mode, are observed during the evaporation-incurred transport process. Here, the creeping motion of an evaporating droplet could be regarded as a self-relaxation process to dispose of the confinement. The slipping mode of motion occurring at the stretched regime is ascribed to the accumulated instability, which is manifested by the relatively larger deviation e from the equilibrium location.

In contrast to the majority of studies that treated droplet evaporation [35, 51] and transport [52-54] as two independent procedures, this disclosure presents description considering these two processes in a combined manner, which provides a new avenue to achieve solvent transport and analyte/colloidal particle concentration in parallel. As such, on the droplet-based microfluidic platform [2, 3], both the deposition location and morphology of the self-assembled micro/nanoparticles can be more accurately predicted and controlled in a passive and decisive approach.

The discussion herein describes several aspects of the apparatus that can be implemented separately or in combination with other aspects of the disclosure without departing from the disclosure. The following lists a non-limiting set of aspects of the display device should not be confused with the claims.

Aspect 1: This aspect includes an apparatus, including a first plate having a first transport surface; a second plate having a second transport surface, the second plate positioned at an acute angle with respect to the first plate such that a first transport surface of the first plate faces the second transport surface of the second plate, where the first transport surface and the second transport surface are hydrophobic; and one or more liquid droplets positioned between and in contact with the first transport surface and the second transport surface.

Aspect 2: The apparatus according to any one of Aspects 1-10, wherein the one or more liquid droplets include suspended colloidal particles or solutes.

Aspect 3: The apparatus according to any one of Aspects 1-10, wherein the acute angle has a value less than 90°.

Aspect 4: The apparatus according to any one of Aspects 1-10, wherein the apparatus has a narrow end and a broad end, and wherein the first plate and the second plate make contact near the narrow end.

Aspect 5: The apparatus according to any one of Aspects 1-10, wherein the apparatus has a narrow end and a broad end, and wherein the first plate and the second plate define a gap near the narrow end.

Aspect 6: The apparatus according to any one of Aspects 1-10, wherein the first transport surface and the second transport surface have a coating comprising at least one of thiol, fluoropolymer, Teflon® or a hydrophobic agent.

Aspect 7: The apparatus according to any one of Aspects 1-10, wherein the first plate and the second plate each have a length between tens of nanometers to several centimeters.

Aspect 8: The apparatus according to any one of Aspects 1-10, wherein the apparatus has narrow end and a broad end, and wherein the one or more liquid droplets, while in a process of evaporation, moves from the broad end to the narrow end without external driving force or momentum.

Aspect 9: The apparatus according to any one of Aspects 1-10, wherein the one or more liquid droplets have a volume between tens of nanoliters to several microliters or even large volume reaching tens of milliliters.

Aspect 10: The apparatus according to any one of Aspects 1-10, wherein at least one of the first transport surface and the second transport surface has a curved surface.

Aspect 11: This aspect includes a method for evaporation-based transport of fluid, including: positioning a liquid droplet at a first end of a transport apparatus, the transport apparatus comprising: a first plate extending between the first end and a second end of the transport apparatus, and a second plate positioned at an angle with the first plate, the second plate extending between the first end and the second end of the transport apparatus, the liquid droplet positioned between the first plate and the second plate nearer to the first end of the transport apparatus; and providing conditions for inducing evaporation in the liquid droplet, causing the liquid droplet to move from the first end towards the second end of the transport apparatus.

Aspect 12: The method according to any one of Aspects 11-20, wherein the liquid droplet is positioned between a first transport surface on the first plate and a second transport surface on the second plate, and wherein the first transport surface and the second transport surface are hydrophobic surfaces.

Aspect 13: The method according to any one of Aspects 11-20, wherein the hydrophobic surfaces comprise at least one of thiol, fluoropolymer or a hydrophobic agent.

Aspect 14: The method according to any one of Aspects 11-20, wherein at least one of the first transport surface and the second transport surface has a curved surface.

Aspect 15: The method according to any one of Aspects 11-20 further comprising: suspending colloidal particles or components in the liquid droplet.

Aspect 16: The method according to any one of Aspects 11-20, wherein the angle has a value that is less than 90° .

Aspect 17: The method according to any one of Aspects 11-20, wherein the first plate and the second plate make contact at the second end.

Aspect 18: The method according to any one of Aspects 11-20, wherein the first plate and the second plate define a gap near the second end.

Aspect 19: The method according to any one of Aspects 11-20, wherein the first plate and the second plate each have a length between tens of nanometers to several centimeters.

Aspect 20: The method according to any one of Aspects 11-20, wherein the liquid droplet moves from the first end to the second end without external driving force or momentum.

References: All cited references, patent or literature, are incorporated by reference in their entirety. The examples disclosed herein are illustrative and not limiting in nature. Details disclosed with respect to the methods described herein included in one example or embodiment may be applied to other examples and embodiments. Any aspect of the present disclosure that has been described herein may be disclaimed, i.e., exclude from the claimed subject matter whether by proviso or otherwise.
[1] M. Zhang, W. Cheng, Z. Zheng, J. Cheng, J. Liu, Meridian whispering gallery modes sensing in a sessile microdroplet on micro/nanostructured superhydrophobic chip surfaces, Microfluid. Nanofluid. 23(9) (2019) 106.
[2] L.R. Shang, Y. Cheng, Y.J. Zhao, Emerging Droplet Microfluidics, Chem. Rev. 117(12) (2017) 7964-8040.
[3] S.Y. Teh, R. Lin, L.H. Hung, A.P. Lee, Droplet microfluidics, Lab Chip 8(2) (2008) 198-220.
[4] M. Grzelczak, J. Vermant, E.M. Furst, L.M. Liz-Marzan, Directed self-assembly of nanoparticles, ACS Nano 4(7) (2010) 3591-3605.
[5] K. Thorkelsson, P. Bai, T. Xu, Self-assembly and applications of anisotropic nanomaterials: A review, Nano Today 10(1) (2015) 48-66.
[6] L. Hu, M. Chen, X. Fang, L. Wu, Oil-water interfacial self-assembly: a novel strategy for nanofilm and nanodevice fabrication, Chem. Soc. Rev. 41(3) (2012) 1350-62.
[7] M.A. Boles, M. Engel, D.V. Talapin, Self-Assembly of Colloidal Nanocrystals: From Intricate Structures to Functional Materials, Chem. Rev. 116(18) (2016) 11220-11289.
[8] J. Song, W. Cheng, M. Nie, X. He, W. Nam, J. Cheng, W. Zhou, Partial Leidenfrost Evaporation-Assisted Ultrasensitive Surface-Enhanced Raman Spectroscopy in a Janus Water Droplet on Hierarchical Plasmonic Micro-/Nanostructures, ACS Nano 14(8) (2020) 9521-9531.
[9] G. Cristobal, L. Arbouet, F. Sarrazin, D. Talaga, J.L. Bruneel, M. Joanicot, L. Servant, On-line laser Raman spectroscopic probing of droplets engineered in microfluidic devices, Lab Chip 6(9) (2006) 1140-1146.
[10] S.K. Kuster, S.R. Fagerer, P.E. Verboket, K. Eyer, K. Jefimovs, R. Zenobi, P.S. Dittrich, Interfacing Droplet Microfluidics with Matrix-Assisted Laser Desorption/lonization Mass Spectrometry: Label-Free Content Analysis of Single Droplets, Anal. Chem. 85(3) (2013) 1285-1289.
[11] Y.M. Zheng, H. Bai, Z.B. Huang, X.L. Tian, F.Q. Nie, Y. Zhao, J. Zhai, L. Jiang, Directional water collection on wetted spider silk, Nature 463(7281) (2010) 640-643.
[12] J. Ju, H. Bai, Y.M. Zheng, T.Y. Zhao, R.C. Fang, L. Jiang, A multi-structural and multi-functional integrated fog collection system in cactus, Nat. Commun. 3(1) (2012) 1-6.
[13] H.G. Andrews, E.A. Eccles, W.C.E. Schofield, J.P.S. Badyal, Three-Dimensional Hierarchical Structures for Fog Harvesting, Langmuir 27(7) (2011) 3798-3802.
[14] K.H. Chu, R. Xiao, E.N. Wang, Uni-directional liquid spreading on asymmetric nanostructured surfaces, Nat. Mater. 9(5) (2010) 413-417.
[15] M.K. Chaudhury, G.M. Whitesides, How to Make Water Run Uphill, Science 256(5063) (1992) 1539-1541.
[18] R.H. Farahi, A. Passian, T.L. Ferrell, T. Thundat, Microfluidic manipulation via Marangoni forces, Appl. Phys. Lett. 85(18) (2004) 4237-4239.
[17] W. Cheng, J. Liu, Z. Zheng, X. He, B. Zheng, H. Zhang, H. Cui, X. Zheng, T. Zheng, B.E. Gnade, J. Cheng, Adaptive optical beam steering and tuning system based on electrowetting driven fluidic rotor, Commun. Phys. 3(1) (2020) 1-9.
[18] J.T. Cheng, C.L. Chen, Active thermal management of on-chip hot spots using EWOD-driven droplet microfluidics, Exp. Fluids 49(6) (2010) 1349-1357.
[19] H. Mertaniemi, V. Jokinen, L. Sainiemi, S. Franssila, A. Marmur, O. Ikkala, R.H.A. Ras, Superhydrophobic Tracks for Low-Friction, Guided Transport of Water Droplets, Adv. Mater. 23(26) (2011) 2911-2914.
[20] C. Mandal, U. Banerjee, A.K. Sen, Transport of a Sessile Aqueous Droplet over Spikes of Oil Based Ferrofluid in the Presence of a Magnetic Field, Langmuir 35(25) (2019) 8238-8245.
[21] Q.Q. Sun, D.H. Wang, Y.N. Li, J.H. Zhang, S.J. Ye, J.X. Cui, L.Q. Chen, Z.K. Wang, H.J. Butt, D. Vollmer, X. Deng, Surface charge printing for programmed droplet transport, Nat. Mater. 18(9) (2019) 936-941.
[22] L.Y. Wang, H.A. Wu, F.C. Wang, Efficient transport of droplet sandwiched between saw-tooth plates, J. Colloid Interface Sci. 462 (2016) 280-287.
[23] M. Ataei, H.C. Chen, A. Amirfazli, Behavior of a Liquid Bridge between Nonparallel Hydrophobic Surfaces, Langmuir 33(51) (2017) 14674-14683.
[24] X. Heng, C. Luo, Liquid Drop Runs Upward between Two Nonparallel Plates, Langmuir 31(9) (2015) 2743-2748.
[25] C. Luo, X. Heng, M.M. Xiang, Behavior of a Liquid Drop between Two Nonparallel Plates, Langmuir 30(28) (2014) 8373-8380.
[26] M. Prakash, D. Quere, J.W.M. Bush, Surface tension transport of prey by feeding shorebirds: The capillary ratchet, Science 320(5878) (2008) 931-934.
[27] T. Han, H. Noh, H.S. Park, M.H. Kim, Effects of wettability on droplet movement in a V-shaped groove, Sci. Rep. 8(1) (2018) 1-10.
[28] C. Luo, M. Mrinal, X. Wang, Self-propulsion of Leidenfrost Drops between Non-Parallel Structures, Sci. Rep. 7(1) (2017) 1-12.
[29] J. Xu, J.F. Xia, S.W. Hong, Z.Q. Lin, F. Qiu, Y.L. Yang, Self-assembly of gradient concentric rings via solvent evaporation from a capillary bridge, Phys. Rev. Lett. 96(6) (2006) 066104.
[30] M. Markos, V.S. Ajaev, G.M. Homsy, Steady flow and evaporation of a volatile liquid in a wedge, Phys. Fluids 18(9) (2006) 092102.
[31] M. Ataei, H.C. Chen, T. Tang, A. Amirfazli, Stability of a liquid bridge between nonparallel hydrophilic surfaces, J. Colloid Interface Sci. 492 (2017) 207-217.
[32] E. Rabani, D.R. Reichman, P.L. Geissler, L.E. Brus, Drying-mediated self-assembly of nanoparticles, Nature 426(6964) (2003) 271-274.
[33] R.D. Deegan, O. Bakajin, T.F. Dupont, G. Huber, S.R. Nagel, T.A. Witten, Capillary flow as the cause of ring stains from dried liquid drops, Nature 389(6653) (1997) 827-829.
[34] W. Xu, Z. Lan, B.L. Peng, R.F. Wen, Y.S. Chen, X.H. Ma, Directional Movement of Droplets in Grooves: Suspended or Immersed?, Sci. Rep. 6(1) (2016) 1-11.
[35] X. He, J. Cheng, C.P. Collier, B.R. Srijanto, D.P. Briggs, Evaporation of squeezed water droplets between two parallel hydrophobic/superhydrophobic surfaces, J. Colloid Interface Sci. 576 (2020) 127-138.
[36] K.A. Brakke, The surface evolver, Exp. Math. 1(2) (1992) 141-165.
[37] M.J. Santos, S. Velasco, J.A. White, Simulation Analysis of Contact Angles and Retention Forces of Liquid Drops on Inclined Surfaces, Langmuir 28(32) (2012) 11828-11835.
[38] M.J. Santos, J.A. White, Theory and Simulation of Angular Hysteresis on Planar Surfaces, Langmuir 27(24) (2011) 14868-14875.
[39] D. Baratian, A. Cavalli, D. van den Ende, F. Mugele, On the shape of a droplet in a wedge: new insight from electrowetting, Soft Matter 11(39) (2015) 7717-7721.
[40] A. Shastry, M.J. Case, K.F. Bohringer, Directing droplets using microstructured surfaces, Langmuir 22(14) (2006) 6161-6167.
[41] L. Xu, Z.G. Li, S.H. Yao, Directional motion of evaporating droplets on gradient surfaces, Appl. Phys. Lett. 101(6) (2012) 064101.
[42] H.B. Eral, D.J.C.M. 't Mannetje, J.M. Oh, Contact angle hysteresis: a review of fundamentals and applications, Colloid Polym. Sci. 291(2) (2013) 247-260.
[43] T. Blake, J. Haynes, Kinetics of liquidliquid displacement, J. Colloid Interface Sci. 30(3) (1969) 421-423.
[44] M. Ataei, T. Tang, A. Amirfazli, Motion of a liquid bridge between nonparallel surfaces, J. Colloid Interface Sci. 492 (2017) 218-228.
[45] X. Yan, Y. Qin, F. Chen, G. Zhao, S. Sett, M.J. Hogue, K.F. Rabbi, X. Zhang, Z. Wang, L. Li, F. Chen, J. Feng, N. Mijkovic, Laplace Pressure Driven Single-Droplet Jumping on Structured Surfaces, ACS Nano 14(10) (2020) 12796-12809.
[46] A. Vandadi, L. Zhao, J. Cheng, Resistant energy analysis of self-pulling process during dropwise condensation on superhydrophobic surfaces, Nanoscale Adv. 1(2) (2019) 1136-1147.
[47] P. Concus, R. Finn, Discontinuous behavior of liquids between parallel and tilted plates, Phys. Fluids 10(1) (1998) 39-43.
[48] D. Baratian, E. Ruiz-Gutierrez, F. Mugele, R. Ledesma-Aguilar, Slippery when wet: mobility regimes of confined drops in electrowetting, Soft Matter 15(35) (2019) 7063-7070.
[49] J.-T. Cheng, J. Morris, J. Tran, A. Lumsdaine, N. Giordano, D. Nolte, L. Pyrak-Nolte, Single-phase flow in a rock fracture: micro-model experiments and network flow simulation, Int. J. Rock Mech. Min. Sci 41(4) (2004) 687-693.
[50] C. Chen, P. Joseph, S. Geoffroy, M. Prat, P. Duru, Evaporation with the formation of chains of liquid bridges, J. Fluid Mech. 837 (2018) 703-728.
[51] H.Y. Erbil, Evaporation of pure liquid sessile and spherical suspended drops: A review, Adv. Colloid Interface Sci. 170(1) (2012) 67-86.
[52] S.J. Lin, B. Li, Y. Xu, A.A. Mehrizi, L.Q. Chen, Effective Strategies for Droplet Transport on Solid Surfaces, Adv. Mater. Interfaces (2020) 2001441.
[53] Y.F. Si, Z.C. Dong, Bioinspired Smart Liquid Directional Transport Control, Langmuir 36(3) (2020) 667-681.
[54] H.Y. Dai, Z.C. Dong, L. Jiang, Directional liquid dynamics of interfaces with superwettability, Sci Adv 6(37) (2020) eabb5528.
[55] X. He, C. Cheng, Evaporation-triggered directional transport of asymmetrically confined droplets, Journal of Colloid and Interface Science, Vol. 604, 15 December 2021, pages 550-561.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

1. An apparatus, comprising:
a first plate having a first transport surface;
a second plate having a second transport surface, the second plate positioned at an acute angle with respect to the first plate such that a first transport surface of the first plate faces the second transport surface of the second plate, wherein the first transport surface and the second transport surface are hydrophobic; and
one or more liquid droplets positioned between and in contact with the first transport surface and the second transport surface.

2. The apparatus of claim 1, wherein the one or more liquid droplets include at least one of suspended colloidal particles, or solutes.

3. The apparatus of claim 1, wherein the acute angle has a value less than 90°.

4. The apparatus of claim 1, wherein the apparatus has a narrow end and a broad end, and wherein the first plate and the second plate make contact near the narrow end.

5. The apparatus of claim 1, wherein the apparatus has a narrow end and a broad end, and wherein the first plate and the second plate define a gap near the narrow end.

6. The apparatus of claim 1, wherein the first transport surface and the second transport surface have a coating comprising at least one of thiol, fluoropolymer, Teflon® or a hydrophobic agent.

7. The apparatus of claim 1, wherein the first plate and the second plate each have a length between tens of nanometers to several centimeters.

8. The apparatus of claim 1, wherein the apparatus has narrow end and a broad end, and wherein the one or more liquid droplets, while in a process of evaporation, moves from the broad end to the narrow end without external driving force or momentum.

9. The apparatus of claim 1, wherein the one or more liquid droplets have a volume between tens of nanoliters to tens of milliliters.

10. The apparatus of claim 1, wherein at least one of the first transport surface and the second transport surface has a curved surface.

11. A method for evaporation-based transport of fluid, comprising:
positioning a liquid droplet at a first end of a transport apparatus, the transport apparatus comprising:
a first plate extending between the first end and a second end of the transport apparatus, and
a second plate positioned at an angle with the first plate, the second plate extending between the first end and the second end of the transport apparatus, the liquid droplet positioned between the first plate and the second plate nearer to the first end of the transport apparatus; and
providing conditions for inducing evaporation in the liquid droplet, causing the liquid droplet to move from the first end towards the second end of the transport apparatus.

12. The method of claim 11, wherein the liquid droplet is positioned between a first transport surface on the first plate and a second transport surface on the second plate, and wherein the first transport surface and the second transport surface are hydrophobic surfaces.

13. The method of claim 12, wherein the hydrophobic surfaces comprise at least one of thiol, fluoropolymer, Teflon® or a hydrophobic agent.

14. The method of claim 12, wherein at least one of the first transport surface and the second transport surface has a curved surface.

15. The method of claim 11, further comprising:
at least one of suspending colloidal particles or solutes in the liquid droplet.

16. The method of claim 11, wherein the angle has a value that is less than 90°.

17. The method of claim 11, wherein the first plate and the second plate make contact at the second end.

18. The method of claim 11, wherein the first plate and the second plate define a gap near the second end.

19. The method of claim 11, wherein the first plate and the second plate each have a length between tens of nanometers to several centimeters.

20. The method of claim 11, wherein the liquid droplet moves from the first end to the second end without external driving force or momentum.
